(19) United States
(12) Patent Application Publication
(10) Pub. No.: US 2025/0245975 A1
(43) Pub. Date: Jul. 31, 2025

(54) Method for Checking the Degree of Realism of Synthetic Training Data for a Machine Learning Model

(71) Applicant: Robert Bosch GmbH, Stuttgart (DE)

(72) Inventor: Andreas Steimer, Schoemberg (DE)

(21) Appl. No.: 19/037,232

(22) Filed: Jan. 26, 2025

(30) Foreign Application Priority Data
Jan. 31, 2024 (DE) 10 2024 200 872.9

(51) Int. Cl. G06V 10/776; G06V 10/75

(52) U.S. Cl. CPC G06V 10/776; G06V 10/751

(57) ABSTRACT

A method for evaluating a degree of realism of synthetic training data for a machine learning model includes (i) providing the synthetic training data, wherein the synthetic training data is described by a statistical quantity, wherein the synthetic training data simulates sensor data, (ii) determining an upper limit of a confidence interval for the statistical value on the basis of the synthetic training data as part of a training of the machine learning model, (iii) providing real data, the real data also being described by the statistical variable, the real data comprising sensor data, the sensor data resulting from the detection of at least one sensor, (iv) determining a lower limit of the confidence interval for the statistical value on the basis of the real data in the context of an inference of the machine learning model, the lower limit being determined continuously from the start of the inference, and (v) checking the degree of realism of the synthetic training data on the basis of a comparison of the continuously determined lower limit with the determined upper limit, wherein a systematic deviation of the synthetic training data from the real data is detected. A computer program, a device, and a storage medium for this purpose is also disclosed.

This application claims priority under 35 U.S.C. § 119 to application no. DE 10 2024 200 872.9, filed on Jan. 31, 2024 in Germany, the disclosure of which is incorporated herein by reference in its entirety.

The disclosure relates to a method for checking the degree of realism of synthetic training data for a machine learning model. The disclosure further relates to a computer program, a device, and a storage medium for this purpose.

### BACKGROUND

In the field of machine learning, synthetically generated data is of great importance. These can be used, for example, to augment data sets if the latter are too small to train classifiers. In this context, an assessment is crucial to determine how realistic these synthetic data are compared to the respective real data that is available.

In the case of image data, a number of indices or metrics from the literature are available to answer this question, for example the so-called FID score. The FID-score correlates particularly well with a subjective human assessment of the degree of realism, but has the serious disadvantage that a number in the order of 10,000 data points or images are required for its calculation.

### SUMMARY

The subject-matter of the disclosure is a method, a computer program, a device, and a computer-readable storage medium having the features set forth below. Further features and details of the disclosure will emerge from the description and the drawings. Features and details which are described in connection with the method according to the disclosure naturally also apply in connection with the computer program according to the disclosure, the device according to the disclosure, and the computer-readable storage medium according to the disclosure, and vice versa in each case, so that reference is always or can always be made to the individual aspects of the disclosure with respect to the disclosure.

The subject matter of the disclosure is, in particular, a method for checking the degree of realism of synthetic training data for a machine learning model, comprising the following steps, wherein the steps can be carried out repeatedly and/or in succession. The degree of realism represents in particular the extent to which the synthetic training data corresponds to real reference images, or, to put it simply, the extent to which the synthetic training data appears real to a user or a machine learning model. This is to determine whether the synthetic training data is suitable for training the machine learning model, as unrealistic training data could lead to a biased machine learning model.

In a first step, the synthetic training data is preferably provided, wherein the synthetic training data is described by a statistical variable. The synthetic training data simulates sensor data in particular. The statistical value can be, for example, a mean value or a variance. In a simplified example, it is conceivable that the statistical quantity represents the mean value of an amplitude of the sensor data. The synthetic training data can, for example, be provided via an analog or digital storage medium or a database, for which a corresponding interface may be provided.

In a further step, a confidence interval for the statistical value is determined, preferably based on the synthetic training data as part of a machine learning model training. The machine learning model can be a supervised learning model, such as a neural network, a support vector machine, or a decision tree, depending on the type of task (classification, regression, etc.). The machine learning model is preferably trained with the synthetic training data. During training, the machine learning model learns to recognize patterns and relationships in the synthetic training data, for example, in order to make predictions or estimates for new, unknown data. The statistical value is preferably calculated after training. This can be, for example, a measure of the model's performance, such as accuracy, F1 score, mean squared error, or an outlier score, depending on the task. As part of a confidence interval calculation, the upper limit of a confidence interval for the previously calculated statistical value is determined. This requires, for example, statistical methods to quantify the uncertainty in the estimation of this variable. This could be done using a Monte Carlo or bootstrap method, where the machine learning model is trained repeatedly with different samples of the synthetic data to obtain a distribution of the statistic. Based on the distribution of the statistical value from the previous step, the upper limit of the confidence interval can be calculated. This value indicates, in particular, the limit below which the true value of the statistical variable will lie with a certain probability (e.g. 95%).

In a further step, real data is preferably provided, wherein the real data is also described by the statistical variable. The real data includes or is in particular sensor data, wherein the sensor data results from the recording of at least one sensor. The sensor data can be image, radar, LiDAR or ultrasonic data, for example.

In a further step, a lower limit of the confidence interval for the statistical value is determined on the basis of the real data as part of an inference of the machine learning model, with the lower limit being determined continuously from the start of the inference. In particular, the inference refers to a process of applying the trained machine learning model to new data, i.e. in particular the real data, in order to provide predictions. The continuous determination can be carried out cyclically, for example every second or every 100 milliseconds. The lower limit is preferably determined in the same way as the upper limit, i.e. using a Monte Carlo or bootstrap method, for example.

In a further step, the degree of realism of the synthetic training data is checked in particular on the basis of a comparison of the continuously determined lower limit with the determined upper limit, wherein a systematic deviation of the synthetic training data from the real data is detected. The comparison is carried out, for example, by calculating the difference between the values for the lower limit determined on an ongoing basis and the upper limit determined. For example, a systematic deviation is detected if the lower limit determined on an ongoing basis exceeds the upper limit determined. This may indicate that the synthetic training data has a low degree of realism and could thus lead to a biased training of a machine learning model.

In particular, a confidence interval is a statistical concept that can be used to describe an uncertainty in estimating a particular parameter, i.e. in the context of the present disclosure, for example, the statistical value, from a sample. In the context of the present disclosure, a confidence interval is preferably a range of values that is assumed to include the true value of an unknown population parameter (e.g. the population mean) with a certain probability, the confidence level. The confidence level, expressed as a percentage (e.g. 95%), indicates the probability that the confidence interval includes the true parameter value. For example, a 95% confidence interval means that if the sampling and interval calculation were repeated thousands of times, the true parameter value would fall within the interval in 95% of those times. A calculation of a confidence interval is based in particular on the sampling distribution of the estimated parameter or statistical value. For the mean, for example, a normal distribution (for larger samples) or a t-distribution (for smaller samples) can be used. The upper and lower limits of the confidence interval are, in particular, the values that delimit the range within which the true value of the parameter under investigation is assumed to lie with a certain probability. These limits can be calculated based on the sample data and the selected confidence level.

For a typical confidence interval for the mean, these limits can be described as follows, for example. In particular, the lower limit is the lowest value of the confidence interval. This can be calculated by multiplying a critical value, which depends on the selected distribution and the confidence level, by a standard error of the sample and subtracting it from the sample mean. In particular, the upper limit is a maximum value of the confidence interval. This can be calculated by multiplying the same critical value as for the lower limit by the standard error of the sample and adding it to the sample mean. The specific values for the upper and lower limits depend in particular on the sample data, the selected confidence level and the applied statistical method.

Preferably, it can be provided that an order is set in the real data in order to determine the lower limit of the confidence interval with the real data with the set order. This is advantageous for taking into account a time dependency in the real data, which can also be relevant when assessing the degree of realism of the synthetic training data. The method is particularly sensitive to the order of the real data. Optimizing the order of the real data can advantageously increase the sensitivity of the method with respect to a real shift in the distribution.

Furthermore, it is conceivable that the method could also include the following steps:
performing the inference on a subset of the synthetic training data, with the lower bound being determined on an ongoing basis.
performing the inference on the basis of the real data, wherein the continuous determination of the lower limit is continued,
checking the synthetic training data based on an analysis of an increase in the continuously determined lower limit when transitioning from the part of the synthetic training data to the real data.

This approach can be used to advantage to additionally conclude that the systematic deviation and consequently the degree of realism in the synthetic training data is low. Thus, in the event of a sharp increase in the lower limit, which is determined on an ongoing basis, when transitioning from the part of the synthetic training data to the real data, there may be a systematic deviation.

It may also be possible that, when checking the synthetic training data, the systematic deviation of the synthetic data from the real data is present if the lower limit determined in each case exceeds the upper limit determined.

It can further be advantageously provided that the method further comprises the step of:
taking an action in response to a result of the synthetic training data check, wherein the action comprises at least initiating an output of a warning message.

The result may indicate, for example, that the synthetic training data shows a systematic deviation and could thus lead to a distorted training of the machine learning model. The warning message may include the presence of this systematic deviation. The output could be via a screen and/or a loudspeaker and thus be graphical and/or audible.

Preferably, the disclosure may provide that the method further comprises the following step:
definition of a threshold for the rate of false alarms.

A false alarm is given in particular when the systematic deviation of the synthetic data from the real data has been detected, but in reality there is no such deviation. If a universe is defined as the realization of infinitely many values for the statistic that is available during the inference phase as a time series without a systematic deviation, and if infinitely many such universes are sampled, then the rate of false alarms indicates in particular the proportion of those universes in which the systematic deviation was erroneously detected after all. This rate of false alarms can also be set as a hyperparameter: The lower this is, the lower a true alarm rate will be, i.e. the rate at which actual systematic deviations are detected. Optimizing the sequence of real data can cause the true alarm rate to rise again.

It is also conceivable that the sensor data includes measurement data, in particular image data, from a production process and the statistical variable represents an error in a particular component. In principle, there can be a multitude of ways to define the statistical measure. For example, an outlier detector output could be used. This means that a systematic deviation in the distribution that is to be detected can be a deviation in the mean of an outlier score of the outlier detector. In other words, a distribution, or a deviation from it, can be characterized by its ability or frequency to generate outliers. It should also be noted that the method particularly takes into account a time course when evaluating a possible deviation. It is also conceivable that the method could be used for optical inspection.

However, this is only one possibility; other definitions are possible in principle. Furthermore, it is also possible to calculate a squaring for each such statistical value, so that the method is not only sensitive to deviations of the mean value, but also of the variance.

The proposed method can be used in a variety of technical applications where the generation of synthetic data is important. For example, the sensor data could be measurement data from a production process, collected for each part produced, and the data could be categorized as OK (functional part) or NOK (defective part). Typically, there are too few reference examples, especially of the NOK data (e.g. for training an OK/NOK classifier), due to the high-quality production, and synthetically generated training data, for example, has to be used.

Another example might be an autonomous or at least partially automated vehicle, where again there are sometimes only a few images available for the wide range of possible traffic scenarios. The vehicle may, for example, be designed as a motor vehicle and/or a passenger vehicle and/or an autonomous vehicle. The vehicle may comprise a vehicle device, e.g., for providing an autonomous driving function and/or a driver assistance system. The vehicle device may be configured to control and/or accelerate and/or brake and/or steer the vehicle, at least partially automatically. Here, too, synthetically generated images can be used to help, and the method described in the present disclosure could be applied.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The FIGURE show:

FIG. 1 a schematic visualization of a method, a device, a storage medium and a computer program according to exemplary embodiments of the disclosure.

### DETAILED DESCRIPTION

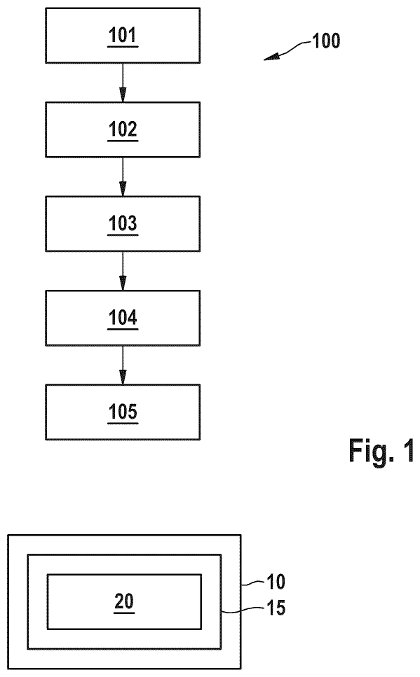

FIG. 1 schematically illustrates a method 100, a device 10, a storage medium 15, and a computer program 20 according to exemplary embodiments of the disclosure.

FIG. 1 shows in particular an exemplary embodiment of a method 100 for checking the degree of realism of synthetic training data for a machine learning model. In a first step 101, the synthetic training data is provided, wherein the synthetic training data is described by a statistical variable, wherein the synthetic training data simulates sensor data. In a second step 102, an upper limit of a confidence interval for the statistical size is determined on the basis of the synthetic training data as part of a training of the machine learning model. In a third step 103, real data is provided, wherein the real data is also described by the statistical variable, wherein the real data includes sensor data, wherein the sensor data results from the recording of at least one sensor. In a fourth step 104, a lower limit of the confidence interval for the statistical value is determined on the basis of the real data as part of an inference of the machine learning model, wherein the lower limit is determined continuously from the start of the inference. In a fifth step 105, the degree of realism of the synthetic training data is checked on the basis of a comparison of the continuously determined lower limit with the determined upper limit, wherein a systematic deviation of the synthetic training data from the real data is detected.

In the method according to the exemplary embodiments, less real data is advantageously required than in the methods according to the prior art, and in addition, it may advantageously be possible to check the rate of false alarms. A false alarm is given in particular when the systematic deviation of the synthetic data from the real data has been detected, but in reality there is no such deviation. The true alarm rate can be increased again by optimizing the sequence.

In the context of the present disclosure, a method from the literature was particularly consulted (https://arxiv.org/abs/2110.06177, hereinafter referred to as the Podkopaev method), the contents of which are hereby referred to. In terms of the method, the synthetic training data in particular would correspond to the “reference data” and the real data to the “test data.” According to the exemplary embodiments, the method is used in particular to detect changes over time in a distribution compared to a reference data distribution. Furthermore, this method can be used to ensure that a freely definable upper limit for the rate of false alarms is not exceeded.

In the context of the present disclosure, the Podkopaev method in particular is used in such a way that synthetic training data serves as a reference distribution and real data, which includes sensor data, serves as a test distribution, with the test distribution preferably following on seamlessly from the reference distribution. It would also be conceivable to swap the roles of the two data sets and obtain a related method. In the Podkopaev method, a lower bound of the so-called “running risk” is continuously calculated during an inference phase on the synthetic training data, for which an upper bound has already been calculated during the training phase. If this lower limit exceeds the (constant) upper limit of the training phase during the test phase, an alarm is triggered and the method detects a change in the distribution, i.e. in particular a systematic deviation.

The lower limit can be calculated for different settings of hyperparameters, e.g. different loss functions. The synthetic training data and the real data can represent examination images from a production line. The training data and the real data can be presented in the same order in which they actually occurred or could occur.

According to an alternative exemplary embodiment, the method described above could also be carried out with a classic hypothesis test such as the t-test or the Wilcoxon sign rank test instead of the Podkopaev method. However, the method described above, which is based on the Podkopaev method, provides different boundaries, allows the use of any loss function as a basis for calculating the running risk, and can also take into account the order in which the real data is entered into the method. The latter can open up additional degrees of freedom, since this order can now be optimized to obtain a test that is as strict as possible, i.e. a test that is based on stricter criteria for the equality of the distribution of both data sets (=null hypothesis) and can thus indicate an inequality, i.e. a systematic deviation, even with smaller deviations. Another advantage of the Podkopaev method is that it is based on less strong assumptions (e.g. regarding normal distribution), as they are present in the classical case, for example.

The above explanation of the embodiments describes the present disclosure solely within the scope of examples. Of course, individual features of the embodiments may be freely combined with one another, if technically feasible, without leaving the scope of the present disclosure.

What is claimed is:

1. A method for evaluating a degree of realism of synthetic training data for a machine learning model, comprising:
providing the synthetic training data, wherein the synthetic training data is described by a statistical quantity, and wherein the synthetic training data simulates sensor data;
determining an upper limit of a confidence interval for the statistical value on the basis of the synthetic training data as part of a training of the machine learning model;
providing real data, wherein the real data is also described by the statistical quantity, wherein the real data comprises sensor data, and wherein the sensor data results from a detection of at least one sensor;
determining a lower limit of the confidence interval for the statistical value on the basis of the real data in the context of an inference of the machine learning model, the lower limit being determined continuously from the start of the inference; and
checking the degree of realism of the synthetic training data on the basis of a comparison of the continuously determined lower limit with the determined upper limit, wherein a systematic deviation of the synthetic training data from the real data is detected.

2. The method according to claim 1, wherein:
an order is specified in the real data in order to determine the lower limit of the confidence interval using the real data with the specified order.

3. The method according to claim 1, further comprising:
performing the inference on a subset of the synthetic training data, with the lower bound being determined on an ongoing basis;
performing the inference on the basis of the real data, wherein the continuous determination of the lower limit is continued; and
checking the synthetic training data based on an analysis of an increase in the continuously determined lower limit when transitioning from the part of the synthetic training data to the real data.

4. The method according to claim 1, wherein:
when checking the synthetic training data, the systematic deviation of the synthetic data from the real data is present if the lower limit determined consecutively exceeds the upper limit determined.

5. The method according to claim 1, further comprising:
taking an action in response to a result of the synthetic training data check, wherein the action comprises at least initiating an output of a warning message.

6. The method according to claim 1, further comprising:
defining a threshold for a rate of false alarms.

7. The method according to claim 1, wherein:
the sensor data includes measurement data of a production process and the statistical variable represents an error of a respective component.

8. A computer program comprising commands for causing the computer to carry out the method according to claim 1 when the computer program is executed by a computer.

9. A device for data processing which is configured to carry out the method according to claim 1.

10. A computer-readable storage medium comprising commands which, when executed by a computer, cause said computer to carry out the steps of the method according to claim 1.

11. The method according to claim 7, wherein the measurement data includes image data.
